(19) United States
(12) Patent Application Publication
(10) Pub. No.: US 2012/0056419 A1
(43) Pub. Date: Mar. 8, 2012

(54) PIPE COUPLING

(75) Inventor: Paul Anthony Davidson, Cheshire (GB)

(73) Assignee: COUPLING TECHNOLOGY LIMITED, Greater Manchester (GB)

(21) Appl. No.: 13/257,366

(22) PCT Filed: Mar. 19, 2010
(86) PCT No.: PCT/GB10/50466

§ 371 Date: Nov. 16, 2011

(30) Foreign Application Priority Data
Mar. 19, 2009 (GB) 0904676.4
Apr. 9, 2009 (GB) 0906136.7
Apr. 22, 2009 (GB) 0909880.0
Apr. 28, 2009 (GB) 0907263.8

(51) Int. Cl. F16L 25/00; F16L 21/02; B23P 11/00; F16L 21/06

(52) U.S. Cl. 285/305; 285/331; 285/330; 137/15.01

(57) ABSTRACT

Disclosed is a pipe coupling for connecting the ends of two tubular conduits comprising: an annular gasket arrangement comprising: an annular ring for straddling two such conduit ends, wherein the annular ring is formed with a pair inwardly facing annular recesses; and a pair of annular sealing elements each located in a corresponding one of the annular recesses and each for sealing around a corresponding one of two such conduit ends; and a casing arrangement comprising a plurality of casing elements connected together by fixing elements so as to surround the gasket arrangement, wherein the casing arrangement comprises a pair of radially inwardly extending projection arrangements, each projection arrangement for engaging an annular groove formed in each such conduit end.

The present invention relates to a coupling for connecting tubular conduits, in particular for connecting lengths of pipe as part of a fluid transport system.

Fluid transport systems are known for conveying materials, such as liquids and gasses. The systems may include domestic plumbing systems installed in a building for conveying, for example, water or oil. These plumbing systems may include pipes for building heating systems, fire protection sprinkler systems and rising mains pipes and waste water pipes. The systems may also include oil and gas pipelines for conveying fuel over thousands of miles and pipe systems used in mining applications. The tubular conduits used in fluid transport of fuel may be made of different metals, including steel, iron, copper, aluminium and plastic.

For smaller diameter pipes, push fit couplings can be used, for example as described in GB2,378,992. However, for pipe diameters above around 5 cms, the force required to push the end of a pipe into such a push fit coupling becomes too high for manual connection. In addition, pipes connected by push fit couplings are able to rotate relative to each other, which can cause valve taps to move out of an optimum position.

For larger diameter pipes, welded joints can be used. However, welded joints have the disadvantage of requiring skilled workers as well as having negative health and safety and environmental implications. For example, the construction of a gas conveying pipeline made from 40 metre long lengths of steel pipe, and with a 1 metre diameter, conventionally use welded joints. Each joint can take a skilled team a whole day to make, when taking into consideration, the deployment of equipment at the joint location and inspection of the joint by X-ray equipment. Also, around 1 in 10 of such welded joints will have to be repaired after such an inspection. This makes pipelines expensive and time consuming to construct.

Where plastic pipes are used, heat fused joints may be used, in which the ends of the pipes to be connected are heated up and then fused together.

Push fit couplings, welded joints and fused joints are difficult to disconnect, for example for repair or maintenance, with such disconnection often causing damage to the pipes.

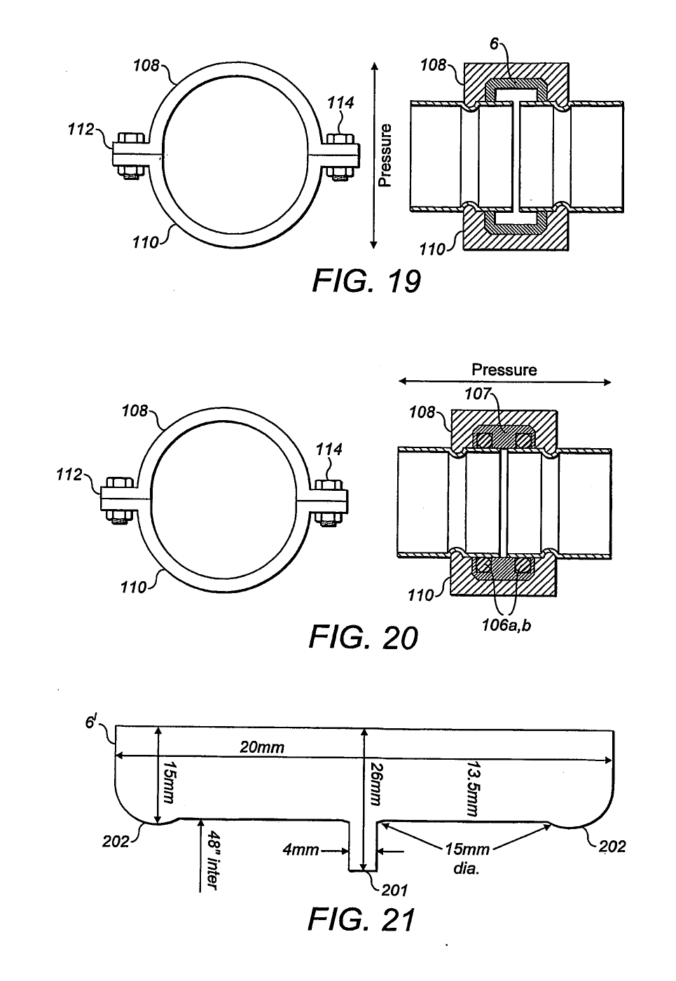

Victaulic (also known as victolic) pipe joints are known in the art, in which the pipe ends to be connected are formed with an annular groove in their external surface. An example of a Victaulic type pipe joint is shown in FIG. 19. An annular resilient gasket (6), with a C-shaped longitudinal cross-section is placed over the pipe ends to be joined, so that the gasket straddles the two pipes. Typically, the gasket is stretched slightly to fit over the pipe ends so as to form a seal between the gasket and the pipes. The gasket is then encased by a rigid Victaulic type casing (108, 110), which engages the grooves formed in the pipe ends. Generally the casing is formed in two halves (108, 110), formed with flanges (112) and the two halves are connected together by bolts (114) passing through the flanges. The casing compresses the sealing gasket (6) to further improve the seal between the gasket and the pipe ends.

There are known problems with such Victaulic pipe joints. The first is that they are not well suited to high pressure pipe systems. In particular where one of the pipe elements coupled together by the joint comprises a pipe end cap, the joint has to withstand significant forces acting to pull the pipe ends connected by the joint apart. When fluid pressure builds up within the pipe joint of FIG. 19, the pressure acts radially outwardly on the gasket, causing the gasket to inflate and apply a radially outwardly directed force to the casing halves (108, 110). That is, the pressure acts in the direction of the double headed arrow, labelled ‘pressure’ in FIG. 19. This force acts to pull the casing halves apart, and so high fluid pressure within the pipe joint of FIG. 19 is transferred to the bolts (114) holding the casing halves (108, 110) together. Such Victaulic type pipe joints are typically rated to fluid pressures of 150 psi and have been know to fail around 200 psi, typically by failure of the bolts (114).

In addition, pipes connected by a Victaulic type pipe joint, of the type shown in FIG. 19, may be able to rotate with respect to each other and with respect to the casing (108, 110), which may cause problems of movement of pipe valves, etc. to inaccessible locations. Victaulic type pipe joints can also fail if the bolts come undone due to vibration of the pipe system.

A first aspect of the present invention aims to overcome at least some of the problems set out above by providing a pipe coupling for connecting the ends of two tubular conduits comprising: an annular gasket arrangement comprising: a rigid annular holding ring for straddling two such conduit ends, wherein the annular ring is formed with a pair inwardly facing annular recesses; and a pair of annular sealing elements each located in a corresponding one of the annular recesses and each for sealing around a corresponding one of two such conduit ends; and a casing arrangement comprising a plurality of casing elements connected together by fixing elements so as to surround the gasket arrangement, wherein the casing arrangement comprises a pair of radially inwardly extending projection arrangements, each projection arrangement for engaging an annular groove formed in each such conduit end.

The casing arrangement may be formed from two casing element halves and each radially inwardly extending projection may comprise an annular wall of the casing arrangement. The casing arrangement may comprise a substantially cylindrical main body for receiving the gasket arrangement. In this case, the main body of the casing arrangement may be located between the pair of radially inwardly extending projection arrangements. An inwardly facing surface of each projection arrangement may be formed with at least one gripping tooth arrangement, which can engage the grooves in the tubular conduit ends so as to prevent relative rotation between the casing and the tubular conduits. The casing elements may be flanged and in this case, may be connected together to form the casing arrangement by fixing elements, such as bolts, passing through abutting flanges.

The rigid annular holding ring may be, at least partially slideably locatable over the conduit ends in order to straddle them. In particular, the holding ring may have a central portion which straddles the conduit ends and may have a sealing element to either side of the central portion. In this case, at least the outer parts of the central portion may be slideably locatable over the conduit ends.

The rigid annular holding ring may have a substantially T-shaped longitudinal (radial) cross-section forming a recess for receiving a sealing element, one to each side of the holding ring. Additionally, the annular ring may comprise a radially inwardly extending annular abutment between the pair of recesses for abutting facing end faces of two such tubular conduits. Each recess of the ring may be formed by a stepped surface which abuts the associated sealing element at a radially outer portion of the sealing element and at a portion of the sealing element closest to the other sealing element. In this case, a retaining ring may be associated with each sealing element so as to cover the sealing element, to the side of the sealing element remote from the central portion of the annular ring of the gasket arrangement. As an alternative, each recess of the ring may be formed by a U-shaped annular channel which abuts the associated sealing element at a radially outer portion of the sealing element and at a portion of the sealing element closest to and furthest away from the other sealing element. The recesses or the combination of the recesses and the retaining rings abut the sealing elements so as to urge them into a sealing engagement with the associated ends of the tubular conduits. The sealing elements may be made of any resilient sealing material known in the art and may, for example be O-ring seals.

At least one of the tubular conduits may be a length of pipe, in particular, the pipe coupling may be used to couple two such lengths of pipe. At least one of the tubular conduits may be a portion of a pipe joint assembly, such as a T-joint or an end cap. The pipe joint assembly may include a valve or other element known in pipe assemblies.

There is also provided a method of assembling the pipe coupling described above comprising the steps of: fixing the gasket arrangement over the ends of the tubular conduits so that the gasket arrangement straddles and seals against the conduit ends; and fixing the casing arrangement around the gasket arrangement with each projection arrangement engaging a groove in a corresponding one of the conduit ends.

A second aspect of the present invention aims to overcome at least some of the problems set out above by providing a pipe coupling for connecting the ends of two tubular conduits comprising: an annular gasket arrangement for straddling and sealing against two such ends; a casing arrangement for surrounding the gasket arrangement, which casing comprises a pair of radially inwardly extending projection arrangements, each projection arrangement for engaging an annular groove formed in each such end; and a fixing sleeve slideably mountable around the casing arrangement.

The gasket arrangement may be a conventional Victaulic type gasket, in which case high fluid pressure transfers to a radially outward force on the casing and thus on the fixing sleeve. This radially outward force acts radially outwardly on the fixing sleeve. Again, this enables a pipe coupling according to the second aspect of the present invention to withstand substantially higher fluid pressures than the type of pipe joint shown in FIG. 19. Failure of the pipe joint according to this second aspect of present invention typically results in rupture of the fixing sleeve, where a Victaulic type gasket is used. In addition, this second aspect of the present invention provides a way of fixing a Victaulic type of pipe coupling, for example using a Victaulic gasket, without requiring bulky flange arrangements connected by bolts. Vibrations, which might cause the bolts to come undone, do not affect the fixing sleeve.

The casing arrangement may abut an outer surface of the gasket arrangement and the projection arrangement may abut a base of such an annular groove in each such tubular conduit.

The casing arrangement may formed from a plurality of casing parts which co-operate together to form the casing arrangement, in particular, the casing arrangement may be formed from two casing halves. The radially inwardly extending projections may comprise an annular wall of the casing arrangement. The casing arrangement may comprise a substantially cylindrical main body and may be formed with a central annular recess on its inwardly facing surface for receiving the gasket arrangement. The end faces of the casing halves may be parallel to a longitudinal plane through the casing or may be angled with respect to a longitudinal plane through the casing.

An inwardly facing surface of each projection arrangement may be formed with at least one gripping tooth arrangement, preferably a plurality of gripping teeth. The or each gripping tooth may extend in the longitudinal direction. The gripping teeth are urged to grip into the base of the grooves in the tubular conduits when the fixing sleeve is secured over the casing arrangement, so as to prevent rotation of the tubular conduits with respect to the pipe coupling.

The fixing sleeve may have a substantially cylindrical outer surface so as to make it particularly easy to lag.

In one embodiment, the outer surface of the casing arrangement may be stepped and the fixing sleeve may be formed with a corresponding step in its inwardly facing surface.

The fixing sleeve may fit over the casing arrangement to form a frictional engagement. In this case, the frictional engagement between the fixing sleeve and the casing may urge the casing radially inwardly. This may act to improve the sealing of the gasket arrangement to the tubular conduits and to improve the engagement between the projection arrangements (optionally toothed) and the grooves in the tubular conduits so as to form a secure sealed coupling between the tubular conduits.

Alternatively, the pipe coupling may additionally comprise at least one fixing element, fixable, for example wedgeable in a frictional engagement or screw fixable, between the fixing sleeve and the casing arrangement so as to secure the fixing sleeve on the casing arrangement. The or each fixing element may have a chamfered end surface to ease the initial engagement of the wedge element between the fixing sleeve and the casing arrangement. The fixing element may extend longitudinally along substantially the entire length of the casing and/or the fixing sleeve. The fixing sleeve may be formed with a recess in its inwardly facing surface for receiving each fixing element. Where the casing arrangement is formed of more than one casing part, each fixing element may engage between the fixing sleeve and opposing end faces of casing parts forming the casing arrangement.

The fixing of the fixing elements between the fixing sleeve and the casing arrangement may urge the casing radially inwardly. This may improve the sealing of the gasket arrangement to the tubular conduits and may improve the engagement between the projection arrangements (optionally toothed) and the grooves in the tubular conduits so as to form a secure sealed coupling between the tubular conduits.

The gasket arrangement may a Victaulic (also known as a victolic) gasket of the types known in the art. Alternatively, the gasket arrangement may comprise a central gasket portion for straddling ends of the two tubular conduits and cylindrical wall portions extending one to either side of the central gasket portion for fitting around end portions of the two tubular conduits. In this latter case, the cylindrical wall portions of the gasket arrangement may be terminated by annular depending rims for engaging a side wall of an annular groove formed in each tubular conduit. The gasket arrangement may be made from a resilient material of a, type suitable for making gaskets or seals.

Alternatively, the gasket arrangement may comprise a seal holding ring and two seals, such that the seals are held in a sealing engagement, one around each tubular conduit end, by the holding ring. In this case, the holding ring may have a T-shaped cross-section forming a recess for receiving a seal, one to each side of the holding ring.

In a lightweight version of the pipe coupling according to the present invention, the casing arrangement may be resilient and may comprise a frame. In this case the frame may be formed with a central annular recess for receiving, and optionally abutting, a central portion of the gasket arrangement and the frame may be formed with annular end portions. Each annular end portion may have a radially inwardly extending portion for engaging an annular groove formed in each tubular conduit. In addition each annular end portion may have a radially outwardly extending portion engageable by the fixing sleeve in a frictional engagement. Then when the fixing sleeve is located over the frame, the fixing element engages the annular end portions of the resilient frame to urge the frame radially inwardly. This may improve the sealing of the gasket arrangement to the tubular conduits and may improve the engagement between the annular end portions (optionally toothed) and the grooves in the tubular conduits so as to form a secure sealed lightweight coupling between the tubular conduits. The central annular recess of the frame and the annular end portions may be connected by an annular wall extending one to either side of the central annular recess. To provide the lightweight character and resilience of the casing arrangement the casing arrangement frame may be formed from sheet metal, for example, sheet spring steel.

The fixing sleeve may comprise an annular depending rim at one end for engaging a side end of the casing arrangement when the fixing sleeve is fitted over the casing arrangement.

The pipe coupling according to the present invention may be a coupling for connecting two lengths of pipe. Alternatively, the pipe coupling according to the present invention may be a coupling for connecting a length of pipe to a pipe joint assembly. Many types of pipe joint assemblies are known, for example pipe joint assemblies for connecting three lengths of pipe in a T-junction, pipe end caps and pipe joint assemblies incorporating valves or other elements known in the art.

There is also provided a method of assembling the pipe coupling according to the second aspect of the present invention, comprising the steps of: fixing the gasket arrangement over the ends of the tubular conduits so that the gasket arrangement straddles and seals against the ends; fixing the casing arrangement around the gasket arrangement with each projection arrangement engaging a groove in a corresponding one of the ends; and slideably mounting the fixing sleeve over the casing arrangement. Where fixing elements are used, the method may additionally comprise the step of fixing the or each fixing element between the fixing sleeve and the casing arrangement.

According to a third aspect of the present invention there is provided a pipe coupling for connecting the ends of two tubular conduits comprising: a gasket arrangement; a casing arrangement comprising a pair of radially inwardly extending projection arrangements, each projection arrangement for engaging an annular groove formed in each such conduit end and comprising a plurality of casing elements connected together by fixing elements so as to be clamped around the gasket arrangement; and a strip of corrugated ribbon locatable between the casing arrangement and each such pipe end with the corrugations extending in a substantially longitudinal direction and deformable into a toothed ring on clamping of the casing arrangement around the gasket arrangement. The gasket arrangement may be an annular gasket arrangement for straddling and sealing around two such conduit ends

Thus, by the incorporation of a strip of corrugated ribbon between the casing arrangement and each of the tubular conduit ends, relative rotation between the casing arrangement and the conduit ends is prevented. This is a simple solution which does not require welding or several complex additional components and is applicable to pipe couplings having a casing which can be clamped together around a gasket arrangement. The pipe coupling may use, for example, a Victaulic type gasket or a gasket arrangement comprising a rigid annular holding ring for holding sealing elements.

The strip of the corrugated ribbon may be located within an annular groove in each such tubular conduit end. For example, it may be located solely in the annular groove or it may be located in the annular grove and an adjacent portion of the tubular conduit end.

There is also provided, a strip of corrugated ribbon, suitable for use in the coupling of the third aspect of the present invention, wherein each corrugation extends substantially across the width of the strip. The strip of corrugated ribbon may be made from a strip of malleable metal, such as stainless steel or aluminium and may have a thickness of between 0.25 and 1 mm, preferably 0.5 mm. The strip of corrugated ribbon may be stored on a roll so that lengths can be cut from the roll, as required.

There is also provided the use of a strip of corrugated ribbon as described above in the pipe coupling of the third aspect of the present invention.

There is also provided a method of assembling a pipe coupling according to the third aspect of the present invention comprising the steps of: fixing the gasket arrangement over the ends of the tubular conduits so that the gasket arrangement straddles and seals against the conduit ends; locating strips of the corrugated ribbon between the casing arrangement and the ends of the tubular conduits; and clamping the casing arrangement around the gasket arrangement so as to deform the corrugated ribbon.

According to a fourth aspect of the present invention, there is provided a pipe coupling for connecting the ends of two tubular conduits comprising: an annular gasket arrangement comprising: an annular ring for straddling two such conduit ends, wherein the annular ring is formed with a pair inwardly facing annular recesses and wherein such coupling ends are slideable within the annular ring; and a pair of annular sealing elements each located in a corresponding one of the annular recesses and each for sealing around a corresponding one of two such conduit ends; and a casing arrangement, surrounding the gasket arrangement and comprising a pair of radially inwardly extending projection arrangements, each projection arrangement for engaging an annular groove formed in each such conduit end and wherein each projection arrangement is slideable longitudinally within such an annular groove.

This provides a simple and yet effective thermal expansion joint, without requiring a large number of complex components. The fourth aspect of the present invention is applicable to pipe joints having a gasket arrangement comprising a holding ring for holding sealing elements, provided the pipe ends are slideable within the holding ring.

According to a fifth aspect of the present invention, there is provided a pipe coupling for connecting the ends of two tubular conduits comprising: an annular gasket arrangement for straddling and for forming a seal against two such conduit ends; a casing arrangement for surrounding the gasket arrangement, which casing comprises a pair of radially inwardly extending projection arrangements, each projection arrangement for engaging an annular groove formed in each such conduit end; and a fixing sleeve slideably mountable around the casing arrangement, wherein the casing arrangement is provided with a bevelled end portion at each end, such that the diameter of the casing arrangement tapers towards the conduits to which it is fitted.

This arrangement removes any sharp changes in diameter at the outer surface of the pipe coupling which could become entangled or snagged with obstructions and helps to minimise damage to the pipeline.

Preferably, the fixing sleeve is further provided with a bevelled edge at one end and a non-bevelled edge at the opposing end, such that the non-bevelled edge abuts, in use, a step provided on the casing arrangement.

The invention will now be described by way of example only and with reference to the accompanying schematic drawings, wherein:

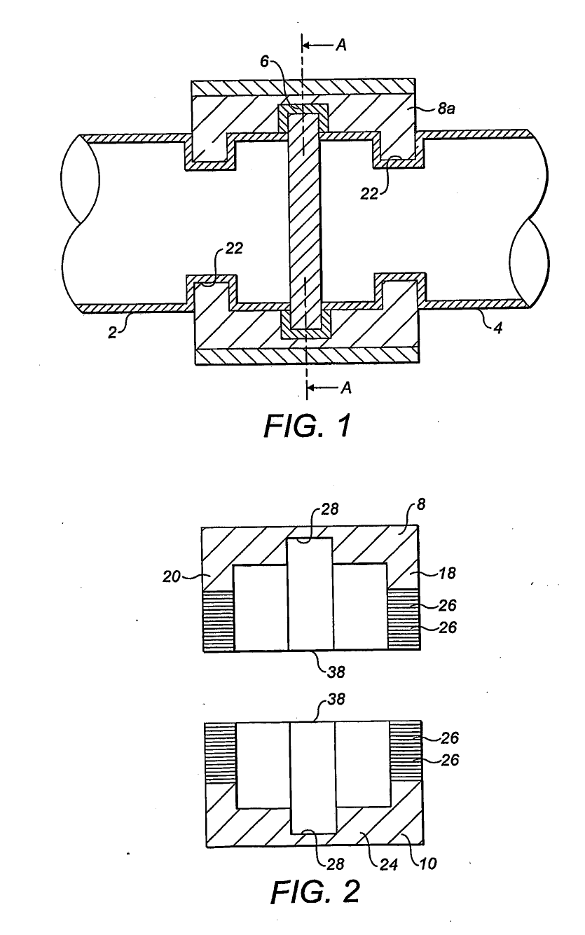

FIG. 1 shows a longitudinal cross-section of a pipe coupling according to the second aspect of the present invention connecting two pipe ends;

FIG. 2 shows a longitudinal cross-section of a two part casing of the pipe coupling of FIG. 1;

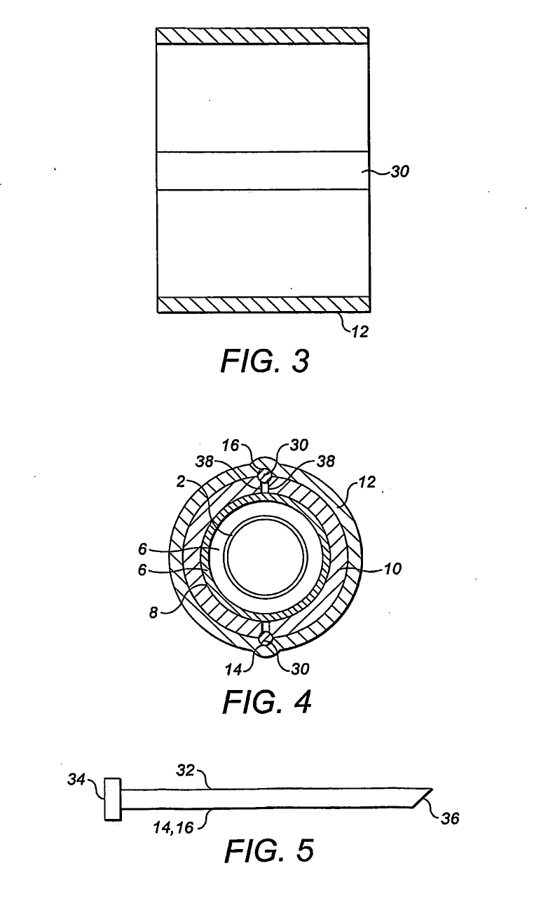

FIG. 3 shows a longitudinal cross-section through a fixing sleeve of the pipe coupling of FIG. 1;

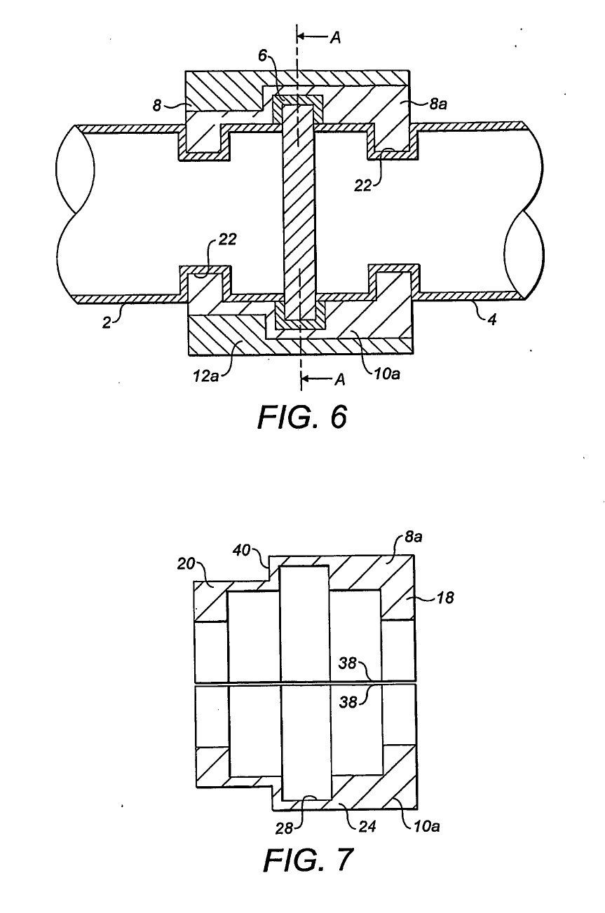

FIG. 4 shows a transverse cross-section through the pipe joint of FIG. 1 or FIG. 6, taken along line AA;

FIG. 5 shows a side view of a wedge element of the pipe joint of FIG. 1 or FIG. 6;

FIG. 6 shows a longitudinal cross-section of a second embodiment of a pipe coupling according to the second aspect of the present invention connecting two pipe ends;

FIG. 7 shows a longitudinal cross-section of a two part casing of the pipe coupling of FIG. 6;

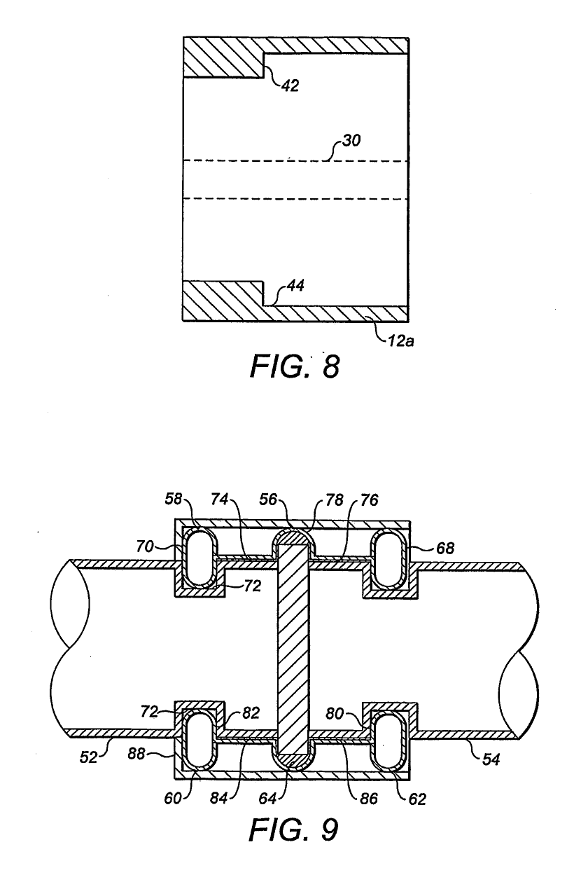

FIG. 8 shows a longitudinal cross-section through a fixing sleeve of the pipe coupling of FIG. 6;

FIG. 9 shows a longitudinal cross-section through a pipe coupling according to the second aspect of the present invention connecting two pipe ends;

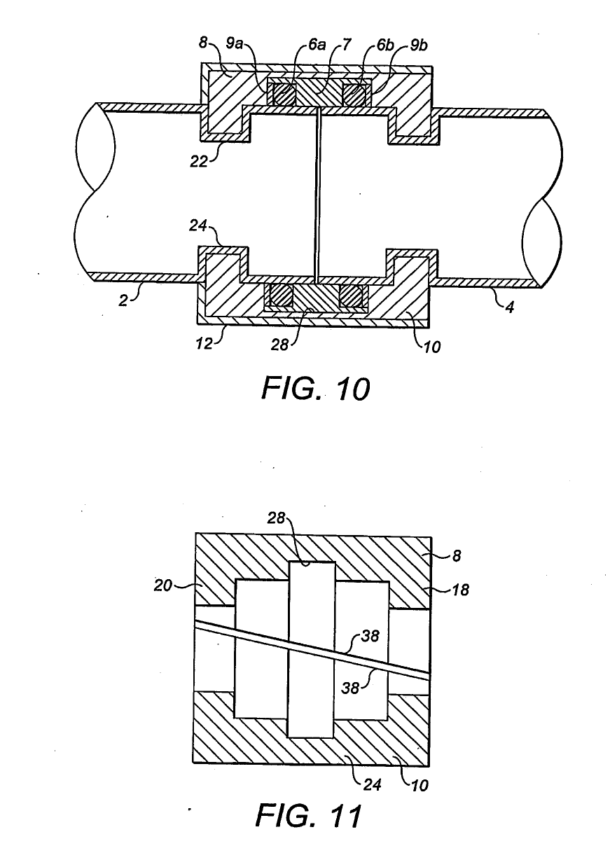

FIG. 10 shows a longitudinal cross-section through a pipe coupling according to the second aspect of the present invention connecting two pipe ends;

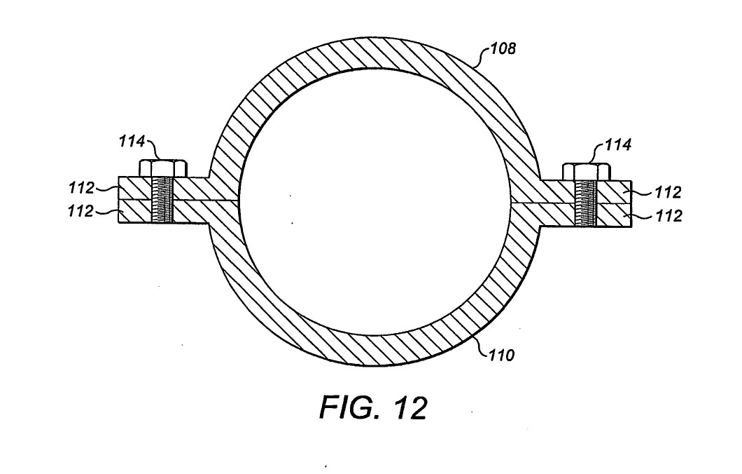

FIG. 11 shows an alternative design of the two part casing to that of FIGS. 2 and 7;

FIG. 12 shows a transverse cross-section of a two part Victaulic type casing, which may be used as an alternative to the casing and fixing sleeve of FIG. 10;

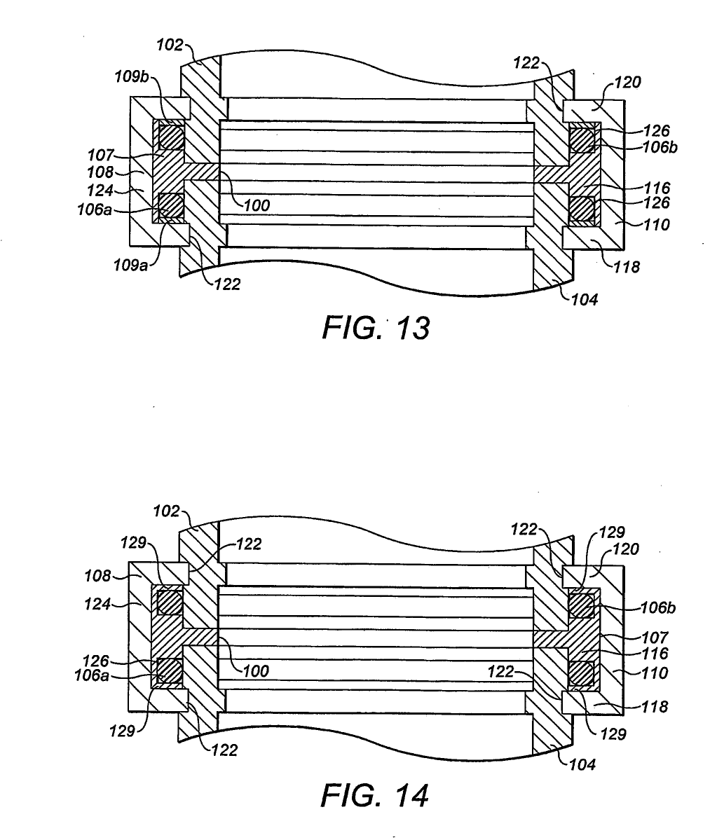

FIG. 13 shows a longitudinal cross-section of a pipe coupling according to the first aspect of the present invention connecting two pipe ends;

FIG. 14 shows a longitudinal cross-section through a variation of the pipe coupling of FIG. 13;

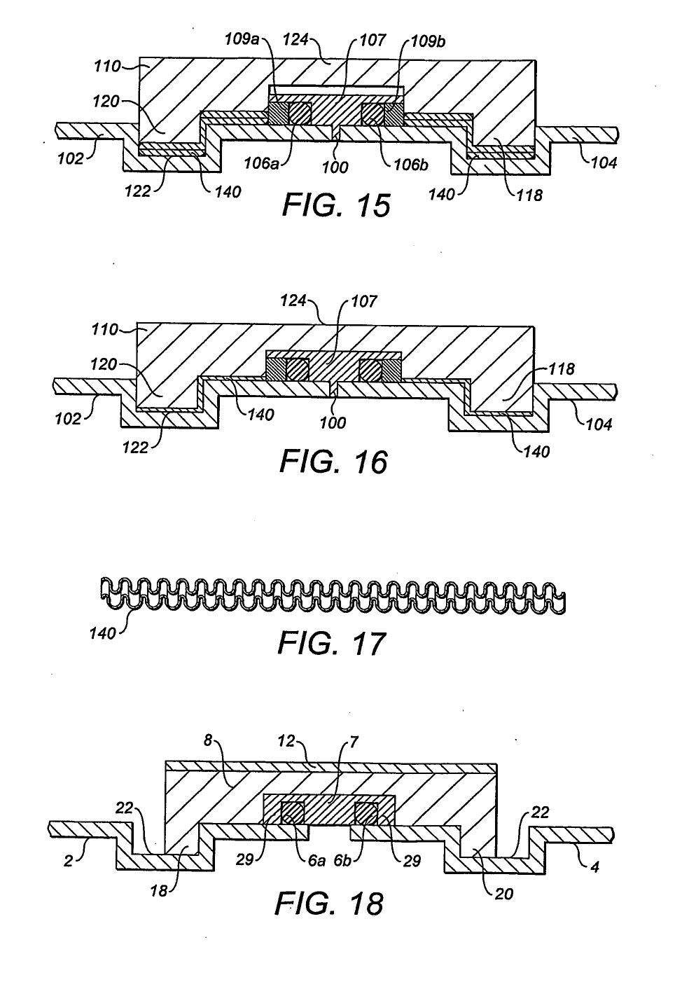

FIG. 15 shows a longitudinal cross-section of a pipe coupling according to a third aspect of the present invention, with the casing in an unclamped position;

FIG. 16 shows a longitudinal cross-section of the pipe coupling of FIG. 14 in a clamped position;

FIG. 17 shows a perspective view of a length of corrugated ribbon used on the pipe couplings of FIGS. 15 and 16;

FIG. 18 shows a longitudinal cross-section through a pipe joint according to a fourth aspect of the present invention;

FIG. 19 shows a transverse cross-section through a Victaulic type casing and a longitudinal cross-section through a Victaulic type pipe coupling, of the type known in the art;

FIG. 20 shows a transverse cross-section through a Victaulic type casing and a longitudinal cross-section through a pipe coupling according to the first aspect of the present invention; and

FIG. 21 shows a cross section through an O-ring seal according to a preferred embodiment of the present invention;

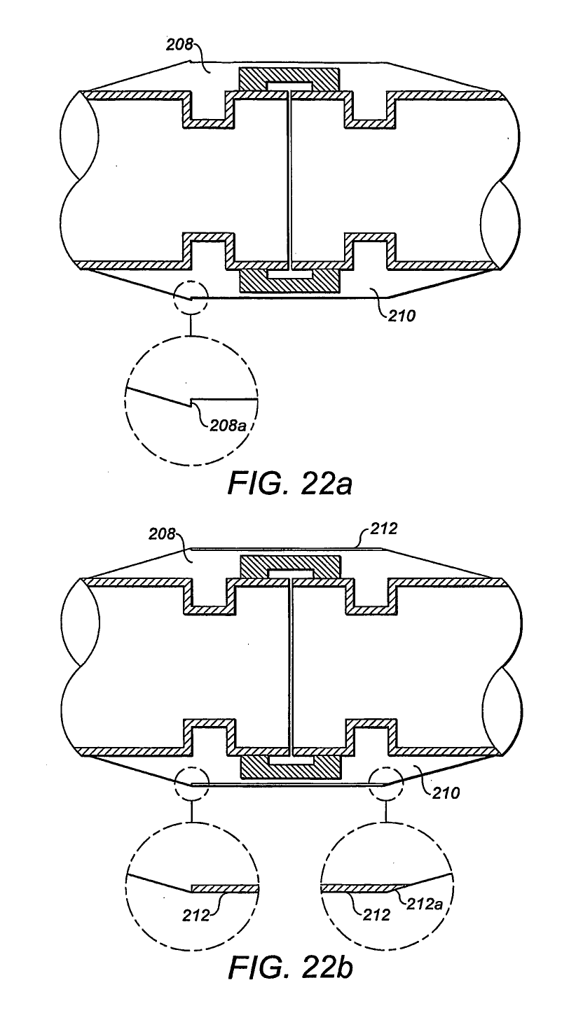

FIGS. 22a and 22b show a longitudinal cross-section of a pipe coupling according to the fifth aspect of the present invention connecting two pipe ends; and

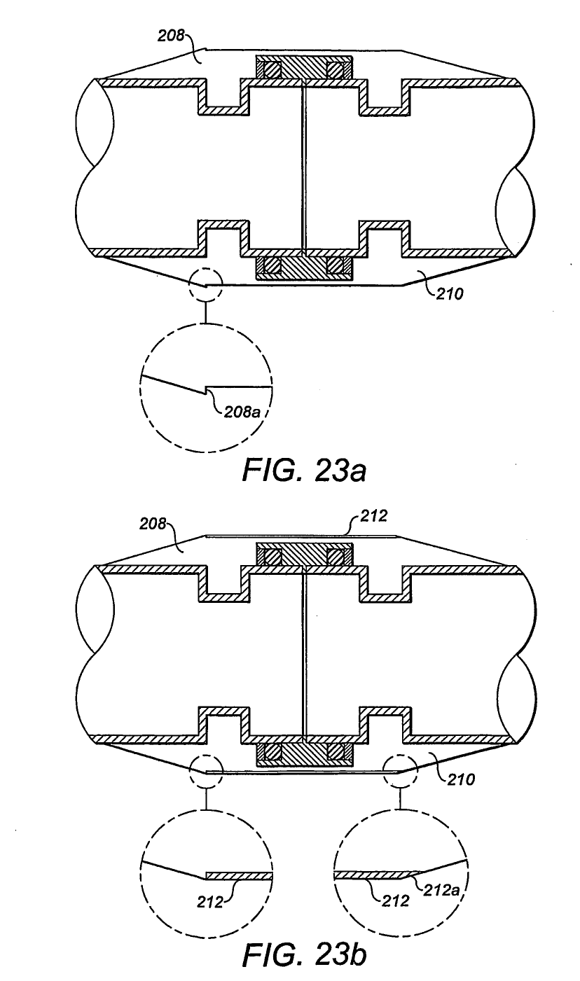

FIGS. 23a and 23b show an alternative longitudinal cross-section of a pipe coupling according to the fifth aspect of the present invention connecting two pipe ends.

The coupling of FIGS. 1 and 4 connects the ends of two lengths of pipe (2, 4) (with only the end portions of the pipes shown) and comprises a gasket (6), two casing halves (8, 10) (also shown in FIG. 2), a fixing sleeve (12) (also shown in FIG. 3) and optionally a pair of wedge elements (14, 16) (one of which is shown in FIG. 5). Each pipe length (2, 4) is formed with or has cut into it an annular groove (22) in its external surface.

The gasket (6) is an annular gasket with a C-shaped longitudinal cross-section and may be of any kind known in the art for use in a Victaulic (or victolic) pipe joint. The gasket is made of resilient sealing material and may, for example, be moulded of natural or synthetic rubber. Other material from which the gasket may be made include, ethylene propylene diene monomer (EPDM) (generally used where the transported fluid is water), a nitrile compound (generally used where the transported fluid is oil), fluoro-elastomer, neoprene, white nitrile and epichlorohydrin.

The casing halves (8, 10) are made of a rigid material and each are shaped generally as a half-annulus with a C-shaped longitudinal cross-section. Two end portions (18, 20) of the casing halves extend radially inwardly of a half-cylinder shaped main body (24) of the casing halves. The end portions (18, 20) have a width and an internal diameter matching the width and the external diameter of the grooves (22) formed in the pipe ends (2, 4) so that the end portions fit into the grooves, when the casing halves (8, 10) are fitted over the gasket (6), as is shown in FIG. 1. The half cylindrical inwardly facing faces of the end portions (18, 20) are formed with a set of longitudinally extending gripping teeth (26). The main body (24) of each casing half (8, 10) is formed with a central half-annular groove (28) in its inwardly facing surface dimensioned to fit over and abut the gasket (6) as is shown in FIG. 1.

The cylindrical fixing sleeve (12), shown in FIG. 3, is made of a rigid material and is dimensioned to fit slideably over the two casing halves (8, 10) when the casing halves are mounted over the gasket (6). In one embodiment, shown in FIG. 1, the fixing sleeve (12) fits over the casing halves (8, 10) and is held in place there by a frictional engagement between the external surface of the casing halves (8, 10) and the inwardly facing surface of the fixing sleeve (12). This frictional engagement urges the casing halves (8, 10) radially inwardly to push against the gasket (6) so as to improve the sealing of the gasket to the tubular conduits (2, 4) and to improve the engagement between the toothed (26) end portions (18, 20) of the casing halves (8, 10) and the grooves (22) in the tubular conduits so as to form a secure sealed coupling between the tubular conduits.

In an alternative embodiment, shown in FIGS. 1 and 4, the fixing sleeve (12) is generally cylindrical in shape but is formed with a pair of opposing longitudinally extending grooves (30) in its inwardly facing surface, each for receiving an associated wedge element (14, 16). The wedge elements (14, 16) each comprise a stem (32), which extends for a distance substantially the same as the length of the fixing sleeve (12) in the longitudinal direction, and a head (34). The end of the stem (32) remote from the head (34) comprises a tapered or chamfered end portion (36). The stem (32) of the wedge element may have a circular or rectilinear transverse cross-section and is dimensioned to fit with a frictional engagement between the grooved portion (30) of the fixing sleeve (12) and the outer portion of the end faces (38) of the casing halves (8, 10). Alternatively, the wedge element (14, 16) may be a screw element, which is screw fixable between the fixing sleeve (12) and the casing halves (8, 10).

The pipe coupling shown in FIGS. 1 and 4 is assembled as follows. The two grooved pipe ends (2, 4) are brought together, with a predetermined space between their facing end surfaces and the annular gasket (6) is stretched to fit over and straddle the pipe ends. The casing halves (8, 10) are then fitted over opposite sides of the gasket (6) with the end portions (18, 20) of the casing halves fitting within the grooves (22) in the pipe ends (2, 4) and the gasket (6) fitting within the groove (28) formed in the main body (24) of the casing halves. With the casing halves (8, 10) in place, the fixing sleeve (12) is fitted over the casing halves.

In one embodiment, the fixing sleeve (12) fits over the casing halves (8, 10) in a frictional fit and so secures the pipe coupling. In an alternative embodiment, with a sleeve (12) comprising the grooves (30), the sleeve is slideably located over the casing halves (8, 10) with the grooves in the sleeve aligned with the opposing end faces (38) of the casing halves. Then a wedge element (14, 16) is fitted into each of the grooves (30) and urged into the space between the grooves and the outer edges of the opposing end faces (38) of the casing halves (8, 10) in a frictional fit. For example, the wedge elements (14, 16) may be hammered or screwed into the grooves (30). This frictional fit of the wedge elements (14, 16) in the grooves (30) secures the pipe coupling. It also urges the gripping teeth (26) on the inwardly facing faces of the casing ends (18, 20) into a gripping engagement with the base of the grooves (22) in the pipe ends so as to prevent relative rotation between each of the pipes (2, 4) and the pipe coupling.

A further embodiment of the pipe coupling is shown in FIGS. 6 to 8, with like parts to FIGS. 1 to 5 indicated by like numerals.

In this embodiment the casing halves (8a, 10a) are each formed with a step (40) on their external surface, which when the casing halves are brought together co-operate to form a casing arrangement with an annular step. The step (40) is formed such that the external diameter of the end portion (20) side of the main body (24) is smaller than the external diameter of the end portion (18) side of the main body of the casing halves (8a, 10a). The fixing sleeve (12a) is formed on its inwardly facing face with a corresponding annular step (42).

The coupling of FIGS. 6 to 8 is assembled as is described above in relation to FIGS. 1 to 5, with the fixing sleeve (12a) assembled onto the casing halves (8a, 10a) from the left hand side in FIGS. 6 to 8.

As before, the fixing sleeve (12a) may be a friction fit onto the casing halves (8a, 10a). In this case the fixing sleeve (12a) may be formed with a set of tapered fins (44), shown in dotted lines in FIG. 8, which fins are deformable to secure the friction fit between the fixing sleeve (12a) and the casing halves (8a, 10a).

Alternatively, the fixing sleeve may be formed with a pair of opposing grooves (30) in a similar way as is described above in relation to FIGS. 3 and 4 and a pair of wedge elements (14, 16) may be urged into the grooves (30), as is described above, giving the pipe coupling of FIG. 6 a transverse cross-section at line AA a transverse cross-section as shown in FIG. 5.

The coupling of FIG. 9 is a lightweight coupling in which the casing is formed from a lightweight frame. The casing in FIG. 9 may be formed from a split ring in a single part or may be formed from a pair of frame halves in two parts. The coupling connects the ends of two lengths of pipe (52, 54) (with only the end portions of the pipes shown) and comprises a gasket (56), a resilient annular frame (58) and a fixing sleeve (62). Each pipe length (52, 54) is formed with or has cut into it an annular groove (72) in its external surface.

The gasket (56) is an annular gasket with a cross-section as shown in FIG. 9. The gasket (56) comprises a central gasket portion (64), formed as an annulus, with a C-shaped cross-section, with the C-shape open in a direction facing radially inwardly. A pair of cylindrical walls (74, 76) extend in a longitudinal direction from opposite sides of the gasket portion (64) and are each terminated by depending annular rim portions (80, 82), which extend radially inwardly of the walls. The gasket is made of resilient material and may be made of the materials described above in relation to the gasket (6).

The resilient annular frame (58) is made of a resilient material for example, sheet metal, for example from sheet spring steel. The longitudinal cross-section of the annular frame (58) is shown in FIG. 9 and from this Figure, it can be seen that the annular frame is formed with a central annulus (78) having a substantially C-shaped cross-section, with the C-shape open in a radially inward direction. A pair of cylindrical walls (84, 86) extend in a longitudinal direction, one to either side of the central annular recess, which walls are each terminated by an annular gripping portion (68, 70), of substantially oval longitudinal cross-section, with a part of the gripping portion extending radially inwardly and a part of the gripping portion extending radially outwardly of the corresponding wall. The radially inwardly extending parts of the oval gripping portions (68, 70) have a width and an internal diameter so that they can fit within the grooves (22) formed in the pipe ends (2, 4) when the frame halves (58, 60) are fitted over the gasket (56), as is shown in FIG. 9. The half cylindrical inwardly facing faces of the gripping portions (68, 70) may optionally be formed with a set of longitudinally extending gripping teeth.

The cylindrical fixing sleeve (62) is made of a rigid material and is dimensioned to fit slideably over the two frame halves (68, 70) when the frame halves are mounted over the gasket (56). The fixing sleeve (62) is formed at one end with a depending annular rim (88), which extends radially inwardly from the main cylinder of the fixing sleeve. The fixing sleeve (62) fits over the frame halves (68, 70) and is held in place there by a frictional engagement due, at least partly to the resilience of the frame halves (68, 70).

The pipe coupling shown in FIG. 9 is assembled as follows. The two grooves pipe ends (52, 54) are brought together, with a predetermined space between their facing end surfaces and the annular gasket (56) is stretched to fit over and straddle the pipe ends. The central gasket portion (64) straddles the end faces of the pipe ends (52, 54) and the cylindrical arm portions (74,76) fit snugly around the outwardly facing cylindrical surface of the pipe ends (52, 54) between the end faces of the pipe ends and the grooves (22) in the pipe ends. The depending annular rims (80, 82) of the gasket (56) fit into the side wall of the grooves (22) proximal to the pipe end faces of the pipe ends (52, 54). The frame halves (68, 70) are then fitted over opposite sides of the gasket (56) with the central annulus (78) of each frame half (68, 70) fitting over and abutting the central gasket portion (64). The annular walls (84, 86) of each frame half (68, 70) lie adjacent to the annular walls (74, 76) of the gasket (56). The gripping portion (68, 70) of each frame half (68, 70) has a radially inwardly extending portion which engages with the side wall of the corresponding groove (22) proximal to the pipe end faces of the pipe ends (52, 54). The gripping portions (68, 70) may also optionally engage the base of a corresponding grooves (22) in the pipe ends (52, 54), as is shown in FIG. 9.

With the frame halves (58, 60) in place, the fixing sleeve (62) is fitted over the frame halves. The fixing sleeve (62) fits over the frame halves (8, 10) in a frictional fit and so secures the pipe coupling. As the fixing sleeve (62) is fitted over the gripping portions (68, 70) of the resilient frame halves (58, 60), it urges the gripping portions radially inwardly into the grooves (72) in the pipe ends (52, 54).

FIG. 11 shows a longitudinal cross-section through an alternative design of casing to that shown in FIGS. 2 and 7, with like parts identified by like numerals. The only difference is that the end faces (38) of the casing halves (8, 10) are angled with respect to a longitudinal plane through the casing. In FIGS. 2 and 7, the end faces (38) of the casing halves (8, 10) are parallel to a longitudinal plane through the casing.

FIG. 10 shows a longitudinal cross-section through a pipe coupling, with an alternative gasket arrangement to that shown in the previous Figures and with like parts labelled by like numerals.

The gasket arrangement comprises an annular O-ring seal holder (7), formed with a central ring with an internal diameter sized to fit slideably over the pipe ends (2, 4) from which extends in the longitudinal direction at the radially outer part of the ring a pair of annular lips. Thus, the annular O-ring seal holder (7) has a T-shaped longitudinal cross-section, with the base of the T radially innermost and the cross-bar of the T radially outermost. The O-ring seal holder (7) is thus formed with two annular recesses, one to either side of the central ring, each for receiving an 0-ring seal (6a, 6b). The O-ring seals (6a, 6b) are dimensioned to fit within the recesses formed in the seal holder (7) and to form a sealing fit around the pipe ends (2, 4). The recesses in the O-ring seal holder (7) are deep enough to receive a retaining ring (9a, 9b) over the corresponding O-ring seal (6a, 6b).

The casing halves (8, 10) are made of a rigid material and each are shaped generally as a half-annulus with a C-shaped longitudinal cross-section. Two end portions (18, 20) of the casing halves extend radially inwardly of a half-cylinder shaped main body (24) of the casing halves. The end portions (18, 20) have a width and an internal diameter matching the width and the external diameter of the grooves (22) formed in the pipe ends (2, 4) so that the end portions fit into the grooves, when the casing halves (8, 10) are fitted over the gasket arrangement (6a, 6b, 7, 9a, 9b), as is shown in FIG. 10. The half cylindrical inwardly facing faces of the end portions (18, 20) may be formed with a set of longitudinally extending gripping teeth (26), as is shown in FIG. 1. The main body (24) of each casing half (8, 10) is formed with a central half-annular groove (28) in its inwardly facing surface dimensioned to fit over and abut the gasket arrangement (6a, 6b, 7, 9a, 9b) as is shown in FIG. 10.

The cylindrical fixing sleeve (12) is made of a rigid material and is dimensioned to fit slideably over the two casing halves (8, 10) when the casing halves are mounted over the gasket arrangement (6a, 6b, 7, 9a, 9b). In FIG. 10, the fixing sleeve (12) fits over the casing halves (8, 10) and is held in place there by a frictional engagement between the external surface of the casing halves (8, 10) and the inwardly facing surface of the fixing sleeve (12).

The pipe coupling shown in FIG. 10 is assembled as follows. An O-ring seal (6a, 6b) and retaining ring (9a, 9b) is fitted, one of each, over each pipe end (2, 4). The two grooved pipe ends (2, 4) are brought together and the O-ring seal holder (7) is fitted over the pipe ends, so as to straddle the pipe ends. The O-ring seals (6a, 6b) are then pushed into the associated recess in the O-ring seal holder (7). This ensures that the O-ring seals (6a, 6b) are not damaged when they are located within the recesses in the O-ring seal holder (7). The retaining rings (9a, 9b) are then fitted into the recesses in the seal holder (7) over the associated O-ring seals (6a, 6b) as is shown in FIG. 10. The casing halves (8, 10) are then fitted over opposite sides of the gasket arrangement (6a, 6b, 7, 9a, 9b) with the end portions (18, 20) of the casing halves fitting within the grooves (22) in the pipe ends (2, 4) and the gasket arrangement fitting within the groove (28) formed in the main body (24) of the casing halves. With the casing halves (8, 10) in place, the fixing sleeve (12) is fitted over the casing halves. The fixing sleeve can fit over the casing halves (8, 10) in a frictional engagement or may be secured in place by wedge elements, as is described above in relation to FIGS. 4 and 5.

A further pipe coupling is shown in FIGS. 12 to 14 and comprises a gasket arrangement similar to that described above in relation to FIG. 10. However, in the pipe couplings of FIGS. 12 to 14 the casing comprises a Victaulic type of casing comprising flanged casing halves (108, 110), with the flanges (112) connected together by fixing elements, in this case bolts (114), as is shown in FIG. 12.

With reference to FIG. 13, the gasket arrangement comprises an annular O-ring seal holder, formed as a ring (107) formed with a central annular inwardly extending abutment (100) having an internal diameter similar to the internal diameter of the pipe ends (102, 104). To either side of the abutment (100) the ring (107) is formed with a stepped internal surface between a first cylindrical surface (116) with an internal diameter sized to fit slideably over the pipe ends (102, 104) to a second cylindrical surface (126) with a larger internal diameter sized to fit over the O-ring seals (106a, 106b). Thus, the stepped surfaces (116, 126) of the ring (107) to either side of the annular abutment (100) form a recess for receiving the O-ring seals (106a, 106b). Thus, the ring (107) has a more or less T-shaped longitudinal cross-section, with the base of the T, formed by the abutment (100), radially innermost, the cross-bar of the T, defining the stepped surfaces (116, 126), radially outermost. The O-ring seals (106a, 106b) are dimensioned to fit within the recesses formed in the ring (107) and to form a sealing fit around the pipe ends (102, 104). The recesses in the ring (107) are deep enough to receive a retaining ring (109a, 109b) over the corresponding O-ring seal (106a, 106b). The retaining rings (109a, 109b) cooperate with the recesses in the ring (107) so as to urge the respective O-ring seals (106a, 106b) into a sealing engagement with the pipe ends (102, 104).

The casing halves (108, 110) are made of a rigid material, in particular metal, and each are shaped generally as a half-annulus with a C-shaped transverse cross-section, as is shown in FIG. 12 in transverse cross-section. As shown in FIG. 13, the casing halves (108, 110) also have a C-shaped longitudinal cross-section. Two end portions (118, 120) of the casing halves extend radially inwardly of a half-cylinder shaped main body (124) of the casing halves, as shown in FIG. 13. The end portions (118, 120) have a width and an internal diameter matching the width and the external diameter of the grooves (122) formed in the pipe ends (102, 104) so that the end portions fit into the grooves, when the casing halves (108, 110) are fitted over the gasket arrangement (106a, 106b, 107, 109a, 109b), as is shown in FIG. 13. The half cylindrical inwardly facing faces of the end portions (118, 120) may be formed with a set of longitudinally extending gripping teeth, in the same way as is described above in relation to the embodiment of FIG. 1. The main body (124) of each casing half (108, 110) has an inwardly facing surface dimensioned to fit over and abut the external surface of the ring (107) of the gasket arrangement (106a, 106b, 107, 109a, 109b) as is shown in FIG. 13. Each casing half is terminated at each end by a flange (112) formed with a hole for receiving a bolt (114).

The pipe coupling shown in FIG. 13 is assembled as follows. An O-ring seal (106a, 106b) and retaining ring (109a, 109b) is fitted, one of each, over each pipe end (102, 104). The two grooved pipe ends (102, 104) are brought together, until the end faces of the pipe ends abut either side of the annular abutment (100) of the ring (107), as is shown in FIG. 13, by sliding the pipe ends within the first cylindrical surfaces (116) from opposing sides of the ring. The O-ring seals (106a, 106b) are then pushed into the associated recesses in the ring (107). This ensures that the O-ring seals (106a, 106b) are not damaged when they are located within the recesses in the O-ring seal holder (107). The retaining rings (109a, 109b) are then fitted into the recesses in the seal holder (107) over the associated 0-ring seals (106a, 106b) as is shown in FIG. 13. The casing halves (108, 110) are then fitted over opposite sides of the gasket arrangement (106a, 106b, 107, 109a, 109b) with the end portions (118, 120) of the casing halves fitting within the grooves (122) in the pipe ends (102, 104) and the gasket arrangement fitting within the main body (124) of the casing halves. With the casing halves (108, 110) in place, the opposing flanges (112) of the casing halves are connected together by bolts, as is shown in FIG. 12, so as to secure the casing halves over the gasket arrangement (106a, 106b, 107, 109a, 109b).

The pipe coupling of FIG. 14 is similar to that of FIG. 13, with like parts identified by like numerals. The main difference is that the ends of the cross-bar of the T-shaped longitudinal cross-section of the ring (107), forming the second cylindrical surfaces (126) are each terminated by inwardly extending annular lips (129). Thus, the annular retaining rings (109a, 109b) are replaced by the annular lips (129) formed integrally with the ring (107). Thus the recesses of the ring (107) cooperate with the annular lips (129) to form a pair of U-shaped recesses for receiving the O-ring seals (106a, 106b). When forming the pipe coupling of FIG. 14, the O-ring seals (106a, 106b) are fitted within the U-shaped recesses before the pipe ends (102, 104) are fitted into the ring (107).

It should be noted that the gasket arrangement of FIGS. 13 and 14 could be used in a pipe coupling comprising a fixing sleeve, for example that shown in FIG. 10 and that the gasket arrangement of FIG. 10 could be used in a pipe coupling comprising a Victaulic type casing of the type shown in FIG. 12.

The first aspect of the present invention provides a pipe coupling that can be used with a Victaulic type casing but in which a conventional Victaulic type of gasket (6), as shown in FIG. 19, is replaced by a gasket arrangement (106, 107) of the type shown in FIG. 20. In the arrangement of FIG. 20, high pressure fluid urges the sealing elements (106a, b) at least partially in a direction away from each other, ie. in a predominantly longitudinal direction, as opposed to radially outwardly (a transverse direction) as in the pipe joint of FIG. 19. So a force is generated urging the longitudinally outer walls of the recesses in which the sealing elements (106a, 106b) are housed, away from each other in the longitudinal direction. That is, the force acts predominantly in the longitudinal direction as shown in FIG. 20 by the double headed arrow labelled ‘pressure’. Thus, the high fluid pressure in the pipe joint is transferred to the engagement between the casing (108, 110) and the grooves in the pipe, rather than to the bolts. This makes the type of pipe joint according to the first aspect of the present invention, for example as shown in FIGS. 13, 14 and 20, able to stand much higher fluid pressure, with the mode of failure of the pipe joint according to the present invention being rupturing of the casing (108, 110), with the rupture extending around the casing (108, 110) in the transverse direction, so as to split the casing (108, 110) into two rings. In addition, the pipe joint according to the first aspect of the present invention achieves a high pressure rating while having relatively few parts.

FIGS. 15 and 16 show a pipe coupling of the type shown in FIG. 13, with like parts identified by like numerals. However, the casing arrangement (108, 110) of the embodiment of FIG. 16 is prevented from rotation with respect to the pipe ends (102, 104) by virtue if the including of at least one length of corrugated ribbon (140) of the type shown in FIG. 17.

The corrugated ribbon (140) comprises a thin strip of a material which will hold its shape, for example the corrugations, but is deformable. For example, the ribbon (140) may comprise a strip of malleable metal, such as stainless steel or aluminium. The ribbon (140) may have a thickness, which may be a substantially constant thickness across the width of the strip, of approximately 0.5 mm, for example between 0.25 mm and 1 mm. The ribbon (14) may be provided as a continuous strip, for example stored on a roll and appropriate lengths of the ribbon may be cut from the roll for use in the pipe joints of FIGS. 15 and 16. In FIG. 17, the strip extends lengthwise between the left and right hand sides of FIG. 17 and the peaks and troughs of each corrugation extend across the width of the strip.

To make the pipe coupling of FIG. 15, the gasket arrangement (107, 106a, 106b, 109a, 109b) is placed over the pipe ends (102, 104), with the holding ring (107) straddling the pipe ends and the O-ring seals (106a, 106b) in a sealing engagement with an associated one of the pipe ends. Then, as each casing half (108, 110) is mounted around the gasket arrangement, a length of the corrugated ribbon (140) is located, one to either side of the gasket arrangement, so that each length of ribbon extends, lengthwise, in a circumferential direction around the corresponding pipe end (102, 104). Thus, the peaks and troughs of each corrugation formed in the ribbon (140) extends in a substantially longitudinal direction. The width of each length of ribbon (140) extends from the side wall of the annular groove (122) in the pipe end remote from the gasket arrangement to the gasket arrangement and is deformed so as to accommodate the step out of the base of the annular groove (122), as is shown in FIG. 15. Two lengths of ribbon (140) may be cut for each casing half (108, 110) (ie. a total of four strips), one located to each side of the gasket arrangement, in which case the lengths of ribbon extend lengthwise, substantially half way around each pipe end. Alternatively, two lengths of ribbon (140) may be cut, for the pipe coupling (ie. a total of two strips), in which case, the lengths of ribbon extend lengthwise, substantially all the way around each pipe end. Thus, the lengths of ribbon (140) are caught between the internal surfaces of the casing halves (108, 110), to either side of the gasket arrangement and the external surface of the pipe ends, including the base of the annular grooves (140), as shown in FIG. 15.

Then when the casing halves (108, 110) are fixed together, by tightening the bolts (114), the lengths of ribbon (140) between the casing halves and the pipe ends (102, 104) are deformed and the corrugations of the length of ribbon, become flattened, as is shown in FIG. 16. The deformed corrugations generate a toothed outwardly facing surface of the ribbon (140) engaging the casing halves (108, 110) and a toothed inwardly facing face of the ribbon (140) engaging the outer surface of the pipe ends (102, 104) so as to prevent relative rotation between the casing halves and the pipe ends. That is, the corrugated ribbon (140) is deformable on clamping of the casing arrangement (108, 110) around the gasket arrangement and the pipe ends (102, 104) so as to form a toothed ring.

A narrower width of the corrugated ribbon (140) may be used, matching the width of the annular grooves (122) in the pipe ends. In this case, the corrugated ribbon (140) is located only in the grooves (122) in the pipe ends (102, 104) and is deformed between the base of the grooves and the annular projections (118, 120) of the casing halves (108, 110), as the bolts (114) are tightened to fix the casing halves together.

Thus, the addition of the corrugated ribbon (140) can be used to prevent relative rotation of the casing halves of a Victaulic type of casing (types shown in FIGS. 12 and 19), with respect to the pipe ends to which it is connected, without requiring, welded parts or the addition of several additional components to the pipe joint.

FIG. 18 shows pipe coupling according to a fourth aspect of the present invention, similar to that shown in FIG. 10, with like parts identified by like numerals. The gasket arrangement is slightly different with the recesses in the holding ring (7), being U-shaped, radially inwardly facing recesses for the O-ring seals (6a, 6b). Thus, the holding ring (7) comprises a pair of depending rims (29) defining a side wall of each U-shaped recess.

In the arrangement of FIG. 18, the holding ring (7) has an internal diameter so as to allow the pipe ends (2, 4) to move slideably within the holding-ring. In addition the width of the annular grooves (22) (in the longitudinal direction) formed in the pipe ends (2, 4) is greater than the width of the casing ends (18, 20) so that the casing ends can move slideably within the grooves in the longitudinal direction. This enables the pipe coupling of FIG. 18 to accommodate thermal expansion of the pipe ends (2, 4).

FIG. 21 shows a cross section through a circumferential portion of an O-ring seal 6′ which is found to be particularly advantageous in embodiments of the present invention. The dimensions shown on the Figure are relevant for an O-ring seal used in 48 inch pipes. The O-ring seal or gasket 6′ comprises a circular gasket for enhancing the seal between two conduit ends. The conduit ends are introduced into the gasket and meet as inwardly radial projection 201. The smaller inwardly radial projections 202 provided at each end of the gasket 6′ assist in forming a seal when there are slight dimensional tolerance issues with the conduits i.e. one or more of them is above or below the nominal dimension.

FIGS. 22a, 22b, 23a and 23b show a variation of the casing arrangement 208, 210 in use in two different configurations of the present invention. The sealing and gasket arrangements used in these two configurations are different, but the operation and function of the casing arrangements is identical and reference should be made to the foregoing description for details of the gasket arrangement which will not be described again here.

When lengths of pipe are coupled, the resulting pipe can be many kilometres long. The effects of thermal expansion and contraction on such a lengthy pipe means that the pipe can move a great distance in a snake-like fashion. In some installations, this movement can cause damage to the pipe couplings which experience extreme mechanical force. This problem can cause the couplings to be ripped off with the consequent problems of pipeline leakage that ensues.

In order to address this particular problem, the pipe couplings shown in FIGS. 22a-23b can be used in appropriate situations. The internal structure of the casing halves 208, 210 i.e. those parts which co-operate with each other and the gasket are identical with those described previously and so will not be set out here again.

The difference to previous embodiments lies in the external profile of the casing arrangement which is arranged to taper gently from its largest diameter portion to the point where it meets the exterior of the pipe such that there are no step changes in the diameter. In this way, in the event that the pipeline moves and contact is made between the coupling and an obstruction, the coupling is more likely to pass smoothly over the obstruction without there being an edge to engage with.

The casing arrangement is composed of two casing halves 208, 210 which co-operate as described previously. The fixing ring 212 is arranged to fit onto the casing arrangement from one direction only. The ring 212 is provided with one edge having an end face perpendicular to the outer surface and another end face which has been bevelled, chamfered or otherwise tapered to remove any step change in diameter.

Once the casing halved 208, 210 have been fitted, the fixing ring 212 is slid into position so that the non-bevelled edge abuts a step 208a provided on the outer surface of each casing half 208, 210. Once the fixing ring is slid fully into place, the opposed tapered end face 212a sits adjacent the tapered end portion of the casing arrangement, so that the diameter of the entire coupling tapers smoothly until it reaches the outer surface of the conduit.

It will be appreciated that various features described in relation to different aspects or embodiments of the present invention can be interchanged to achieve particular effects in particular circumstances. For instance, the casing halves 8, 10 may be replaced by any other suitable casing halves, such 208, 210 shown in FIGS. 22a, 22b, 23a and 23b, if the chamfered edges of the latter are needed in a particular installation of the pipe coupling. Other substitutions and swaps are also clearly possible and embodiments of the present invention should not be considered limited to the particularly illustrated embodiments include herein.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A pipe coupling for connecting the ends of two tubular conduits comprising:
an annular gasket arrangement comprising:
an annular ring for straddling two such conduit ends, wherein the annular ring is formed with a pair inwardly facing annular recesses; and
a pair of annular sealing elements each located in a corresponding one of the annular recesses and each for sealing around a corresponding one of two such conduit ends; and
a casing arrangement comprising a plurality of casing elements connected together by fixing elements so as to surround the gasket arrangement, wherein the casing arrangement comprises a pair of radially inwardly extending projection arrangements, each projection arrangement for engaging an annular groove formed in each such conduit end.

2. A pipe coupling according to claim 1 wherein the casing arrangement is formed from two casing element halves.

3. A pipe coupling according to claim 1 wherein each radially inwardly extending projection comprises an annular wall of the casing arrangement.

4. A pipe coupling according to claim 1 wherein the casing arrangement comprises a substantially cylindrical main body for receiving the gasket arrangement.

5. A pipe coupling according to claim 3 wherein the main body of the casing arrangement is between the pair of radially inwardly extending projection arrangements.

6. A pipe coupling according to claim 1 wherein an inwardly facing surface of each projection arrangement is formed with at least one gripping tooth arrangement.

7. A pipe coupling according to claim 1 wherein the casing elements are flanged and are connected together to form the casing arrangement by fixing elements passing through abutting flanges.

8. A pipe coupling according to claim 1 wherein the annular ring has a substantially T-shaped longitudinal cross-section forming a recess for receiving an O-ring seal, one to each side of the holding ring.

9. A pipe coupling according to claim 1 wherein the annular ring additionally comprises a radially inwardly extending annular abutment between the pair of recesses for abutting facing end faces of two such tubular conduits.

10. A pipe coupling according to claim 1 wherein each recess of the ring is formed by stepped surface which abuts the associated sealing element at a radially outer portion of the sealing element and at a portion of the sealing element closest to the other sealing element.

11. A pipe coupling according to claim 10 wherein a retaining ring is associated with each sealing element so as to cover the sealing element, to the side of the sealing element remote from a central portion of the annular ring of the gasket arrangement.

12. A pipe coupling according to claim 1 wherein each recess of the ring is formed by a U-shaped annular channel which abuts the associated sealing element at a radially outer portion of the sealing element and at a portion of the sealing element closest to and furthest away from the other sealing element.

13. A pipe coupling according to claim 1 wherein at least one of the tubular conduits is a length of pipe.

14. A pipe coupling according to claim 1 wherein at least one of the tubular conduits is a portion of a pipe joint assembly.

15. A method of assembling a pipe coupling according to claim 1, the method comprising the steps of:
fixing the gasket arrangement over the ends of the tubular conduits so that the gasket arrangement straddles and seals against the conduit ends; and
fixing the casing arrangement around the gasket arrangement with each projection arrangement engaging a groove in a corresponding one of the conduit ends.

16. A pipe coupling for connecting the ends of two tubular conduits comprising:
an annular gasket arrangement for straddling and for forming a seal against two such conduit ends;
a casing arrangement for surrounding the gasket arrangement, which casing comprises a pair of radially inwardly extending projection arrangements, each projection arrangement for engaging an annular groove formed in each such conduit end; and
a fixing sleeve slideably mountable around the casing arrangement.

17. A pipe coupling according to claim 16 wherein the casing arrangement is formed from a plurality of casing parts which co-operate together to form the casing arrangement.

18. A pipe coupling according to claim 17 wherein the casing arrangement is formed from two casing halves.

19. A pipe coupling according to claim 16 wherein each radially inwardly extending projection comprises an annular wall of the casing arrangement.

20. A pipe coupling according to claim 16 wherein the casing arrangement comprises a substantially cylindrical main body.

21-49. (canceled)

50. A pipe coupling for connecting the ends of two tubular conduits comprising:
a gasket arrangement;
a casing arrangement comprising a pair of radially inwardly extending projection arrangements, each projection arrangement for engaging an annular groove formed in each such conduit end and comprising a plurality of casing elements connected together by fixing elements so as to be clamped around the gasket arrangement; and
a strip of corrugated ribbon locatable between the casing arrangement and each such pipe end with the corrugations extending in a substantially longitudinal direction and deformable into a toothed ring on clamping of the casing arrangement around the gasket arrangement.

51. A coupling according to claim 50 wherein a strip of the corrugated ribbon is located within an annular groove in each such tubular conduit end.

52-57. (canceled)

58. A pipe coupling for connecting the ends of two tubular conduits comprising:
an annular gasket arrangement comprising:
an annular ring for straddling two such conduit ends, wherein the annular ring is formed with a pair of inwardly facing annular recesses and wherein such coupling ends are slideable within the annular ring; and
a pair of annular sealing elements each located in a corresponding one of the annular recesses and each for sealing around a corresponding one of two such conduit ends; and a casing arrangement, surrounding the gasket arrangement and comprising a pair of radially inwardly extending projection arrangements, each projection arrangement for engaging an annular groove formed in each such conduit end and wherein each projection arrangement is slideable longitudinally within such an annular groove.

59. A pipe coupling for connecting the ends of two tubular conduits comprising:
an annular gasket arrangement for straddling and for forming a seal against two such conduit ends;
a casing arrangement for surrounding the gasket arrangement, which casing comprises a pair of radially inwardly extending projection arrangements, each projection arrangement for engaging an annular groove formed in each such conduit end; and
a fixing sleeve slideably mountable around the casing arrangement, wherein the casing arrangement is provided with a bevelled end portion at each end, such that the diameter of the casing arrangement tapers towards the conduits to which it is fitted.

60. A pipe coupling as claimed in claim 59 wherein the fixing sleeve is further provided with a bevelled edge at one end and a non-bevelled edge at the opposing end, such that the non-bevelled edge abuts, in use, a step provided on the casing arrangement.
